(19) United States
(12) Patent Application Publication
(10) Pub. No.: US 2008/0233552 A1
(43) Pub. Date: Sep. 25, 2008

(54) METHOD OF CROSS-LINKING AMNION TO BE AN IMPROVED BIOMEDICAL MATERIAL

(76) Inventors: David Hui-Kang Ma, Taipei City (TW); Jan-Kan Chen, Tao-Yuan (TW); Chen-Chi Tsai, Jhonghe City (TW)

Correspondence Address: Alan D. Kamrath;NIKOLAI & MERSEREAU, P.A., 900 Second Ave. S., # 820, Minneapolis, MN, 55402, US

(21) Appl. No.: 11/689,933

(22) Filed: Mar. 22, 2007

(51) Int. Cl. A01N 1/00

(52) U.S. Cl. 435/1.1

(57) ABSTRACT

The present invention discloses a method of cross-linking amnion to be an improved biomedical material. The present invention adopts the amnion cross-linked by EDC (N-(3-dimethylaminopropyl)-N′-ethyl-carbodiimide HCI) or NHS (N-hydroxysuccinimide), and the cross-linked amnion not only has more resistance to protease, but also binds specific extracellular matrix (ECM) such as heparin by using cross-linked functional group. Further, by using the affinity of the ECM with specific growth factors, the amnion can be an efficient carrier for specific growth factor. Hence, some specific diseases may be treated.

### FIELD OF THE INVENTION

The present invention is related to a method of cross-linking amnion to be an improved biomedical material, more particularly to a method for maintaining the softness of the tissue and increased resistance to proteolytic destruction of the amnion following transplantation, in order to improve the function of amnion as a biomedical material.

### BACKGROUND OF THE INVENTION

Preserved human amnion as a biomedical material has been applied for the treatment of ocular surface diseases with outstanding performances. The amnion is a natural basement membrane and contains plenty of growth factors so as to improve the adhesion and growth of epithelial cells. The membrane is also rich in anti-inflammatory and anti-angiogenic factors so as to inhibit inflammation on the surface of the eye. Therefore, it is beneficial to apply amnion transplantation to speed up healing of corneal ulcer and inhibit recurrence of pterygium. Recently, the amnion is considered a kind of “niche” to maintain the growth of limbal stem cell in vitro so as to facilitate the tissue engineering technology of “cultivating limbal stem cells on amnion then transplantation to patient”.

However, clinically amnion is from a placenta obtained after normal pregnancy, by that time the bonding force of collagen of the amnion has become weaker, and the degree of collagen cross-linkage of amnion is the lowest among various kinds of natural basement membrane. Thus, to treat a severe inflammatory disease associated with increased protease secretion on an eye such as severe corneal ulcer, chemical burn, and autoimmune diseases such as Stevens-Johnson syndrome, the transplanted amnion might be dissolved and causes treatment failure.

After working on the related issues for many years, the inventors recently found out a method to solve the problem mentioned above.

### SUMMARY OF THE INVENTION

The problem to be solved is that the amnion has the lowest collagen cross-linkage among various kinds of natural basement membrane, thus to treat a severe inflammation disease accompanied with increased protease secretion on an eye (or in a wound), the transplanted amnion might be dissolved and causes treatment failure.

The primary objective of the present invention is to provide a method of cross-linking the amnion to be a biomedical material more resistant to proteases. The present invention adopts the amnion cross-linked by EDC (N-(3-dimethylaminopropyl)-N′-ethyl-carbodiimide HCI), thereby endows the amnion more resistance to proteases from a wound. Hence, the cross-linked amnion may last longer than a natural amnion in an inflammatory wound, and will not be dissolved. On the other hand, the cross-linked amnion as a matrix to cultivate limbal stem cells will slow down the proliferation of the cells in vitro, so as to maintain the stem cell property in the graft longer following transplantation.

Wherein heparin can be a mediator that facilitates binding of a group of growth factors to the cross-linked amnion so that the amnion may serve as a carrier for specific growth factors. Hence, the device can be used to improve treatment of some specific diseases, such as regeneration of burned skin, or the antiaging and the face-lifting of a cuticle film.

Compared with prior technique, the present invention adopts collagen cross-linkage of the amnion by EDC, and the cross-linked amnion not only has more resistance to protease, but also can bind specific extracellular matrix (ECM) such as heparin by using cross-linked functional group. Further, by using the affinity of the ECM and specific growth factors, the amnion can be a highly performing carrier for at least one specific growth factor. Hence, some specific diseases may be treated with the device.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 illustrates a flow chart of a first preferred embodiment of the present invention;

FIG. 2 illustrates a flow chart of the cross-linking of the present invention; and

FIG. 3 illustrates a flow chart of a second preferred embodiment of the present invention.

### DETAILED DESCRIPTIONS OF THE PREFERRED EMBODIMENT

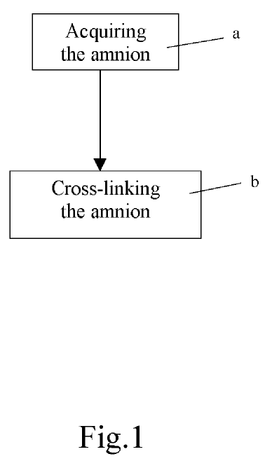

The present invention discloses a method of cross-linking amnion to be an improved biomedical material. With reference to FIG. 1, which illustrates a flow chart of a first preferred embodiment of the present invention and includes the steps of:

(1) Amnion acquirement: The amnion is obtained from placenta after full-term delivery, the placenta is kept in an aseptic double-layered bag under 4° C. and then processed within 24 hours. In a biosafety chamber, the amnion is rinsed by copious aseptic normal saline so as to remove blood clots, then the amnion and chorion are dissociated; after cleaning the blood clots, the amnion is cut into a size of 6×6 cm and kept in 10 mL preservation solution which contains DMEM and glycerin with the ratio of 1:1, then the amnion is preserved in a −70° C. refrigerator. Upon processing, the amnion is taken out from the refrigerator and defrosted.

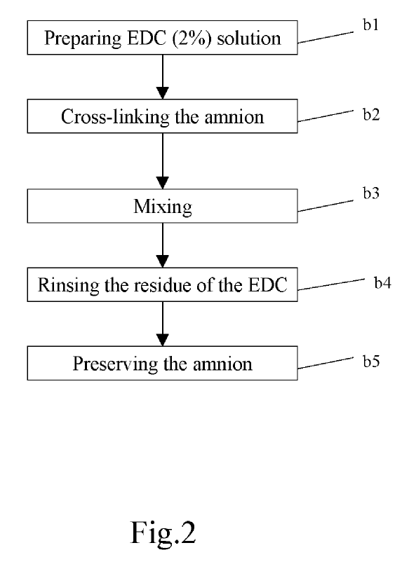

(2) With reference to FIG. 2, which illustrates a flow chart of the cross-linking process of the present invention, the preparation of 2% (weight) EDC (N-(3-dimethylaminopropyl)-N′-ethyl-carbodiimide HCI) solution: First, prepare 100 ml acetic acid solution (95 ml de-ionized water titrated by 0.5 M acetic acid, until the pH value is adjusted to 4.0, then add some water until the whole volume is 100 ml), then mix 2 wt % EDC powder with the acetic acid solution.

(3) Amnion cross-linking: Cross-link the amnion with 2 wt % EDC solution, and continuously adjusting the pH value of the cross-linking EDC solution to 4.7 by using the 0.5 M acetic acid; wherein the amnion before cross-linking is rinsed by 1×PBS (phosphate-buffered saline).

(4) Mixing: Put the amnion under cross-linking reaction in an incubator at 37° C., and mix the amnion and the EDC solution for 16 hours at low speed stirring or shaking, not to damage the amnion.

(5) Rinse: Rinse the cross-linked amnion for 30 minutes with 30 wt % alcohol with the volume of 100 ml, then rinse the amnion with bulk 1× PBS for three times, 4 hours each for the first two times, and overnight at 4° C. for the third time to thoroughly remove the residual EDC (de-ionized water can also be used for this purpose).

(6) Preservation: Preserve the amnion in 30 wt % alcohol under the temperature of 4° C.

The present invention adopts the amnion cross-linked by EDC, and adds more resistance of the amnion to proteases. Hence, the cross-linked amnion may last longer than the original amnion in an inflammatory wound, and will be less likely to become dissolved. On the other hand, the cross-linked amnion may function as a niche for the cultivation of limbal stem cells, and since the proliferation rate of the stem cells is lowered, relatively the graft may live longer in vitro.

Wherein heparin can be a mediator to bind fibroblast growth factor (FGF)-related growth factors, and using the affinity of the cross-linked amnion with heparin, the cross-linked amnion may function as an efficient carrier for specific growth factors such as keratinocyte growth factor (KGF; FGF-7), which maintains the stem cell population of the corneal epithelium. Hence, this device may help to treat some specific diseases, such as improving the regeneration of burned skin, or as an antiaging, face-lifting cuticle film.

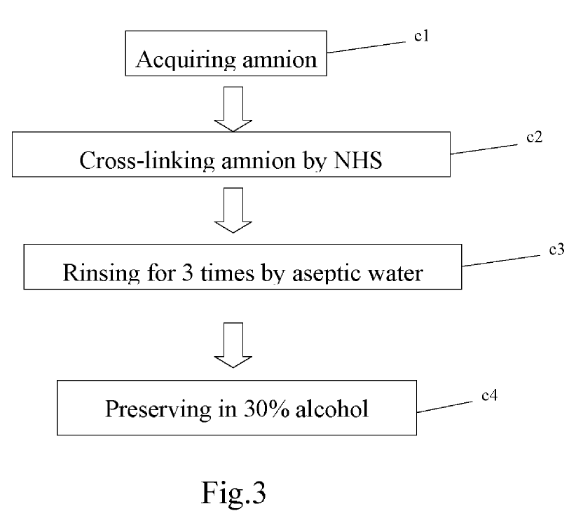

With reference to FIG. 3, which illustrates a flow chart of a second preferred embodiment of the present invention, and includes the steps of:

(1) Amnion acquirement: Thawing of the amnion.

(2) NHS cross-linking: Rinse the amnion for three times by using PBS, then add 2 wt % NHS (N-hydroxysuccinimide) to react for 3 hours under room temperature and pH value of 4.7.

(3) Aseptic water rinsing: Use aseptic water to rinse the amnion for 3 times.

(4) Preservation: Preserve the amnion in 30 wt % alcohol.

As a conclusion, the reacted amnion is applied for the analysis of materials, such as cross-link exponent, denature temperature, mechanical strength, cell compatibility, performance test, etc.

While the present invention has been particularly shown and described with reference to the preferred embodiments, it will be understood by those skilled in the art that various changes in form and detail may be without departing from the spirit and scope of the present invention.

What is claimed is:

1. A method of cross-linking amnion to be a biomedical material, comprising the steps of:
(1) amnion acquirement: thawing of the amnion;
(2) preparation of 2 wt % EDC solution: prepare 100 ml acetic acid solution, then mix 2 wt % EDC powder with the acetic acid solution;
(3) amnion cross-linking: cross-link the amnion and the 2 wt % EDC solution, and continuously adjust the pH value of the cross-linking EDC solution to 4.7 by using 0.5 M acetic acid;
(4) mixing: put the cross-linked amnion in an incubator at 37° C., and mix the amnion and the EDC solution for 16 hours at a low speed;
(5) rinse: rinse the cross-linked amnion for 30 minutes with 30 wt % alcohol with the volume of 100 ml, then rinse with bulk 1× PBS for three times, 4 hours each for the first two times, and overnight at 4° C. for the third time to thoroughly remove the residual EDC; and
(6) preservation: preserve the amnion in 30 wt % alcohol under 4° C.

2. The method of cross-linking the amnion to be a biomedical material as claimed in claim 1, wherein the amnion is from the placenta obtained after Cesarean section, the placenta is put in an aseptic double-layered bag under 4° C. and then processed within 24 hours. In a biosafety chamber, the amnion is rinsed by copious aseptic normal saline so as to clean blood clots. The amnion and chorion are separated, after cleaning blood clots, then the amnion with a size of 6×6 cm is placed in a preservation solution containing 10 mL preservation solution, including DMEM and glycerin with the ratio of 1:1, and the amnion is preserved in a −70° C. refrigerator. Upon use, the amnion is taken out from the refrigerator and thawed.

3. The method of cross-linking the amnion to be a biomedical material as claimed in claim 1, wherein preparing 100 mL acetic acid solution is: first to prepare 95 mL de-ionized water, then adjust the pH value to 4.0 by using 0.5 M acetic acid, and add water up to 100 mL.

4. The method of cross-linking the amnion to be a biomedical material as claimed in claim 1, wherein the amnion before cross-linking is rinsed by 1×PBS (phosphate-buffered saline).

5. The method of cross-linking the amnion to be a biomedical material as claimed in claim 1, wherein the low speed of mixing follows the principle of not damaging the amnion by way of stirring.

6. The method of cross-linking the amnion to be a biomedical material as claimed in claim 1, wherein shaking is the way of mixing.

7. A method of cross-linking amnion to be a biomedical material, comprising the steps of:
(1) amnion acquirement: thawing the amnion;
(2) NHS cross-linking: rinsing the amnion for three times by using PBS, then adding 2 wt % NHS (N-hydroxysuccinimide) to react for 3 hours under the room temperature and the pH value of 4.7;
(3) aseptic water rinsing: using the aseptic water to rinse the amnion for 3 times; and
(4) preservation: preserve the amnion in alcohol with 30 wt %.
